(19) United States
(12) Patent Application Publication
(10) Pub. No.: US 2018/0154201 A1
(43) Pub. Date: Jun. 7, 2018

(54) DEVICES FOR ENERGY HARVESTING AND STORAGE

(71) Applicant: Uncharted Power, Inc., New York, NY (US)

(72) Inventors: Jessica Osemudiamen Idoni Matthews, New York, NY (US); Julia Claire Silverman, Cambridge, MA (US); Victor Angel Mosti, Brooklyn, NY (US); Joel Manalo, Los Angeles, CA (US)

(21) Appl. No.: 15/835,395

(22) Filed: Dec. 7, 2017

Related U.S. Application Data
(63) Continuation of application No. 14/490,271, filed on Sep. 18, 2014, now abandoned.
Application No. 14/490,271 is a continuation-in-part of application No. 13/565,474, filed on Aug. 2, 2012, now Pat. No. 9,517,388.
(60) Provisional application No. 61/879,396, filed on Sep. 18, 2013.
(60) Provisional application No. 61/521,826, filed on Aug. 10, 2011.

(51) Int. Cl. A63B 5/20; H02N 2/18; F03G 5/06; A63B 21/005

(52) U.S. Cl. CPC A63B 5/20; A63B 2220/12; H02N 2/181; A63B 2220/58; A63B 43/04; F03G 5/06; A63B 2220/833; A63B 21/0054; A63B 2220/53

(57) ABSTRACT

Provided is an energy harvesting device, comprising a first shell having a longitudinal axis, wherein the first shell defines a cavity, and a second shell, wherein the second shell is mechanically connected to the first shell via a flexible cord, wherein the cavity comprises therein a bearing, an electrical generator, and a battery, wherein the bearing is mechanically coupled to a rotor of the electrical generator at a first end and an end of the flexible cord at a second end, such that rotation of the flexible cord about the longitudinal axis rotates at least a portion of the bearing to generate electrical power, and wherein the rotor is in electrical communication with the battery, such that the battery stores at least a portion of the electrical power generated by the electrical generator.

### CROSS-REFERENCE

This application is a continuation of U.S. Utility application Ser. No. 14/490,271, filed Sep. 18, 2014, which claims the benefit of U.S. Provisional Application No. 61/879,396, filed Sep. 18, 2013, and is a continuation-in-part of U.S. Utility application Ser. No. 13/565,474, filed Aug. 2, 2012, now U.S. Pat. No. 9,517,388, which claims the benefit of U.S. Provisional Application No. 61/521,826, filed Aug. 10, 2011, each which applications are incorporated herein by reference in their entirety.

### FIELD OF THE INVENTION

The present invention relates to a ball having a generation module disposed therein. More specifically, the present invention relates to a soccer ball having a generation module disposed in a cavity of the ball, wherein the generation module generates electrical energy from the balls kinetic energy and stores that electrical energy.

### BACKGROUND OF THE INVENTION

The total number of individuals in the World without electric power is put at about 1.5 billion, or a quarter of the world's population, concentrated mostly in Africa and southern Asia. See Nathanial Gronewold, One-Quarter of World's Population Lacks Electricity, Scientific American (Nov. 24, 2009). This “energy poverty” is a serious problem that has dire environmental, health, and economic consequences, especially for families in the developing world. With few other alternatives, households without reliable access to electricity often depend on pollutant kerosene lamps to provide extra hours of light after the sun goes down. The noxious fumes from the burning kerosene are bad for the environment and for respiratory health: just one night of exposure to the kerosene smoke is equivalent to smoking two packs of cigarettes. Furthermore, kerosene is expensive: a family can spend up to 30% of their income on kerosene each year. See Eva Rehfuess, Fuel for Life: Household Energy and Health, World Health Organization (Geneva: 2006). Further, there are now widely available technologies that can significantly improve the conditions of those people living in remote parts of the world, but these devices also require electricity to operate. For example, a farmer in a remote area can use a relatively inexpensive cellular phone to monitor market prices for her crops and to help decide when and where to harvest and sell her crops. This information can substantially increase the price offered for the product to the farmer, but only if the farmer has access to electrical energy to operate the cellular phone. With respect to both lighting and technological access, the lack of readily available electricity is a significant problem.

### SUMMARY OF THE INVENTION

In one embodiment, the present invention resides in one or more shells. A device may comprise a first shell having a longitudinal axis, wherein the first shell defines a cavity, and a second shell, wherein the second shell is mechanically connected to the first shell via a flexible cord, wherein the cavity comprises therein a bearing, an electrical generator, and a battery, wherein the bearing is mechanically coupled to a rotor of the electrical generator at a first end and an end of the flexible cord at a second end, such that rotation of the flexible cord about the longitudinal axis rotates at least a portion of the bearing to generate electrical power, and wherein the rotor is in electrical communication with the battery, such that the battery stores at least a portion of the electrical power generated by the electrical generator.

In yet a further embodiment, a socket is disposed in the first handle. The socket accessible from an outside surface of the handle, and the socket is electrically coupled to battery. In yet another embodiment of the present invention, electrical energy stored in the battery can be accessed via the socket.

In yet another embodiment of the present invention, a printed circuit board is disposed in the first handle. The electric generator, the battery, and the socket are electrically connected via the printed circuit board.

The present invention resides in one aspect in a ball. The ball includes a shell that defines a cavity. A generation module is disposed in the cavity and fixed relative to the shell. The generation module has a pendulum and an electric generator. The pendulum is coupled to the electric generator so that the electric generator converts a swinging of the pendulum to electrical energy.

In some embodiments of the present invention, a battery is electrically coupled to the electric generator and the battery stores electrical energy generated by the electric generator. The ball may further include a socket electrically coupled the battery and accessible from an outside surface of the shell.

In some embodiments of the present invention, the generation module further includes a rigid housing and the pendulum, the electric generator, and the battery are disposed in the rigid housing. In some embodiments, the pendulum is configured in the rigid housing so that a rotation of the pendulum is restricted about a first axis of rotation. The pendulum extends between a proximal end and distal end. A rotor of the electric generator is coupled to pendulum proximate to the first axis of rotation. The pendulum comprises a bob at or proximate to its distal end.

In some embodiments of the present invention, the pendulum is supported at the first axis of rotation by a first support and a second support. The first support is laterally displaced from the second support along the first axis of rotation. In yet further embodiments of the present invention, a rod of the pendulum and the bob extend in a plane perpendicular to the first axis of

rotation from a point along said first axis of rotation between the first support and the second support. In some embodiments of the present invention, the pendulum is at least 20 grams. In yet further embodiments the pendulum is approximately 30 grams.

In some embodiments of the present invention, the electric generator is a 6 volt direct current motor and the battery is a 3.7 volt 800 mAh lithium-ion battery.

In yet further embodiments of the present invention, the shell includes a panel. The panel has a sleeve that extends radially inward from an inner surface of the panel. The generation module is secured inside the sleeve and the panel is secured in the shell. In some embodiments of the present invention the shell comprises ethylene vinyl acetate.

The present invention resides in other aspects in a soccer ball. The soccer ball includes a shell defining a spheroid having a cavity disposed therein. The shell includes an opening and a panel configured to substantially close the opening. The panel has a sleeve that extends radially inward from an inner surface of the panel. The soccer ball further includes a generation module disposed in the cavity and fixed relative to the shell. The generation module includes a housing. A pendulum, an electric generator, and a battery are disposed in the housing. The pendulum is mechanically coupled to a rotor of the electric generator at or proximate to a first axis of rotation of the pendulum and the electric generator is electrically coupled to the battery. An acceleration of the soccer ball relative to a playing surface causes the pendulum to rotate about the first axis of rotation. The rotation of the pendulum rotates the rotor of the electric generator. The rotation of the rotor of the electric generator generates electricity, and at least a portion of the generated electricity is stored by the battery.

### BRIEF DESCRIPTION OF THE DRAWINGS

FIG. 1 is an exploded front view of a ball in accordance with one embodiment of the present invention.

FIG. 2 is an exploded perspective view of a generation module shown in FIG. 1.

FIG. 3 is a partially exploded perspective view of a portion of the generation module shown in FIG. 1.

FIG. 4 is a top view of a portion of the generation module shown in FIG. 1.

FIG. 5 is a side view of a pendulum shown in FIG. 2.

FIG. 6 is a top view of a portion of the generation module shown in FIG. 1.

FIG. 7 is a front view of the ball shown in FIG. 1.

FIG. 8 is a wiring diagram of a printed circuit board in accordance with one embodiment of the present invention.

FIG. 9 is an exploded perspective view of a generation module in accordance with one embodiment of the present invention.

FIG. 10A is an exploded view of a ball in accordance with one embodiment of the present invention.

FIG. 10B is an exploded view of the ball shown in FIG. 10A.

FIG. 10C is a view of the ball shown in FIG. 10A.

FIG. 11 is an exploded view of an American football.

FIG. 12 is an exploded view of a handle of a jump rope.

FIG. 13 is a view of a jump rope in accordance with one embodiment of the present invention, wherein the jump rope is connected to a smart phone for charging the smart phone.

### DETAILED DESCRIPTION OF THE INVENTION

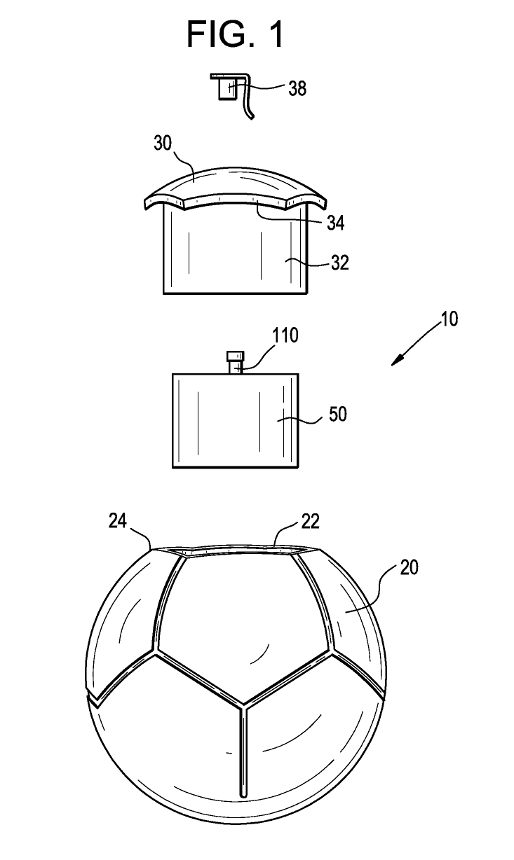

In reference to the FIGS. generally and with specific reference to FIG. 1, a ball 10 in accordance with one embodiment of the present invention is shown. The ball 10 includes a generally spherical shell 20 that defines a cavity 22. The ball 10 includes a generation module 50 that harnesses kinetic energy of the ball 10 to generate and store electrical energy. The shell 20 defines an opening 24 for accessing the cavity 22 and includes a panel 30 for substantially closing the opening 24 defined by the shell 20. The panel 30 includes a cylindrical sleeve 32 that extends radially inward from an inner surface 34 of the panel 30. During assembly the generation module 50 is secured in the sleeve 32 and the panel 30 is secured in the opening 24 defined by the shell 20 so that the sleeve 32 is disposed in the cavity 22. A socket 110 is electrically coupled to the generation module 50 and is accessible through an opening (not shown in FIG. 1) defined by the panel 30. A cap 38 closes the opening defined by the panel 30 during recreational play with the ball 10 and the socket 110 is accessible from outside the ball when the cap 38 is removed from the opening defined by the panel 30.

In the embodiment shown, the shell 20 is generally spherical and has a diameter approximate to that of a standard soccer ball. The present invention, however, is not limited in this regard as the shell 20 may define different shapes. For example, the shell 20 may define a spheroid approximating the dimensions of an American football. Additionally the shell 20 may approximate a baseball, a basketball, or any other type of ball. The shell 20 is made from cross linked ethylene-vinyl acetate (EVA). The EVA is injection molded to form the spherical shape of the shell 20. In the embodiment shown, the shell 20 is approximately between 10 mm and 12 mm in thickness, although the present invention is not limited in this regard and the thickness of the shell 20 may vary from ball to ball or from location to location within a specific shell. Cross linked EVA and the specified selected thickness were selected to emulate the look and feel of a standard soccer ball without requiring a pressurized bladder disposed in the cavity 22 of the shell 20.

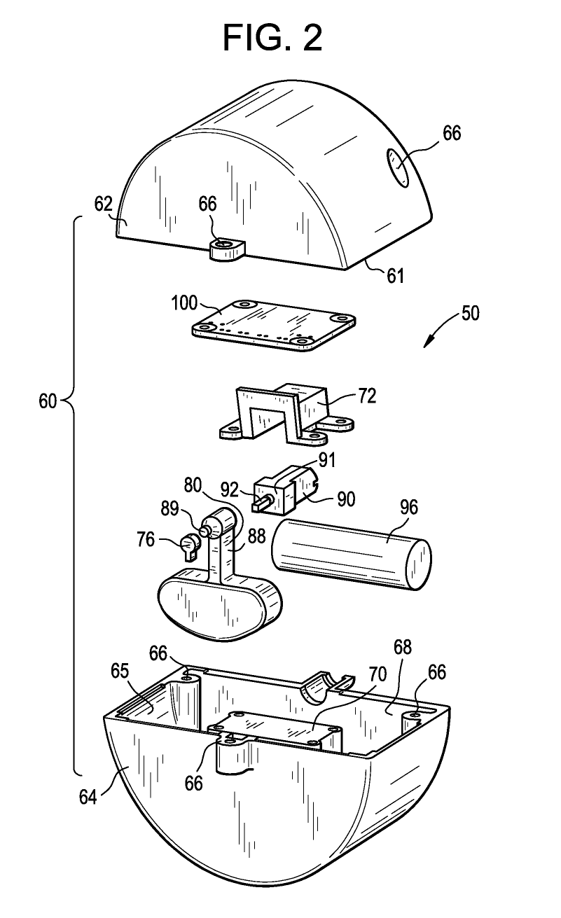

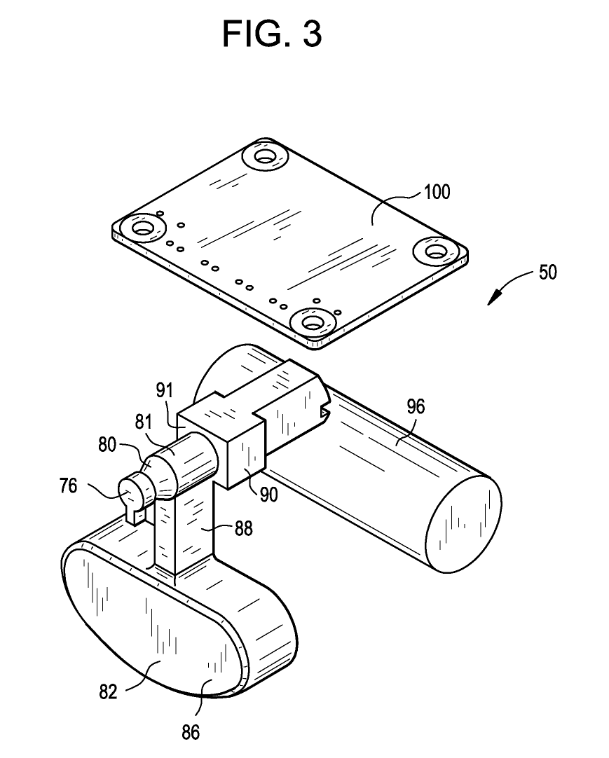

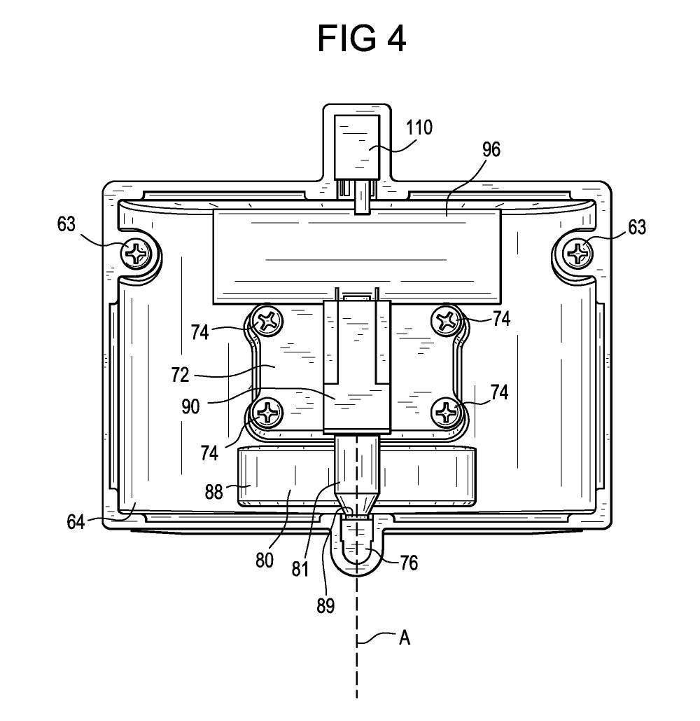

In reference to FIG. 2, an exploded view of the generation module 50 is shown. The generation module 50 includes a housing 60, a pendulum 80, an electric generator 90, a battery 96, and supporting hardware including one or more brackets and fasteners as discussed in detail below. The housing 60 includes a first section 62 and a second section 64. The first section 62 and the second section 64 are generally symmetrical and are secured together by one or more fasteners 63 (shown in FIG. 4) received through one or more holes 66 in the housing 60. The housing 60 defines a cavity 68 when the first section 62 and the second section 64 are secured together. The inner surfaces of the first section 62 and the second section 64 of the housing 60 are configured to receive and stabilize the pendulum 80, the electric generator 90, and the battery 96. In the embodiment shown, the housing 60 is manufactured by injection molding acrylonitrile butadiene styrene. It should be understood, however, that the present invention is not limited in this regard and, as can be appreciated by a person having ordinary skill in the art, different manufacturing techniques and materials may be employed. Acrylonitrile butadiene styrene was selected for the housing 60 because it secures and protects the internal components of the generation module 50 under high impact conditions experienced during use of the ball 10.

In the embodiment shown, the electric generator 90 comprises a 6 volt direct current motor with an 11:1 gear ratio. This gear ratio and motor were selected to optimize generation of electrical energy with a soccer ball. It should be understood that the type and gearing of the electric generator is not limited to this embodiment and a person of ordinary skill in the art familiar with this disclosure would recognize that different gearing and motor combinations may be used with the present invention. The electric generator 90 includes a rotor 92 extending from a surface 91 of the electric generator 90. Rotation of the rotor 92 operates the electric generator 90 causing it to generate electrical energy. Although a specific electric generator 90 is disclosed herein, the present invention is not limited in this regard and many different types of motors may be employed to convert rotational motion of the pendulum 80 to electrical energy. The electric generator 90 is mounted on pedestal 70 extending from an inner surface 65 of the second section 64 of the housing 60. A U-shaped bracket 72 is mounted over the electric generator 90 and to the pedestal 70 using a plurality of fasteners 74 (shown in FIG. 4) to secure the electric generator 90 to the pedestal 70.

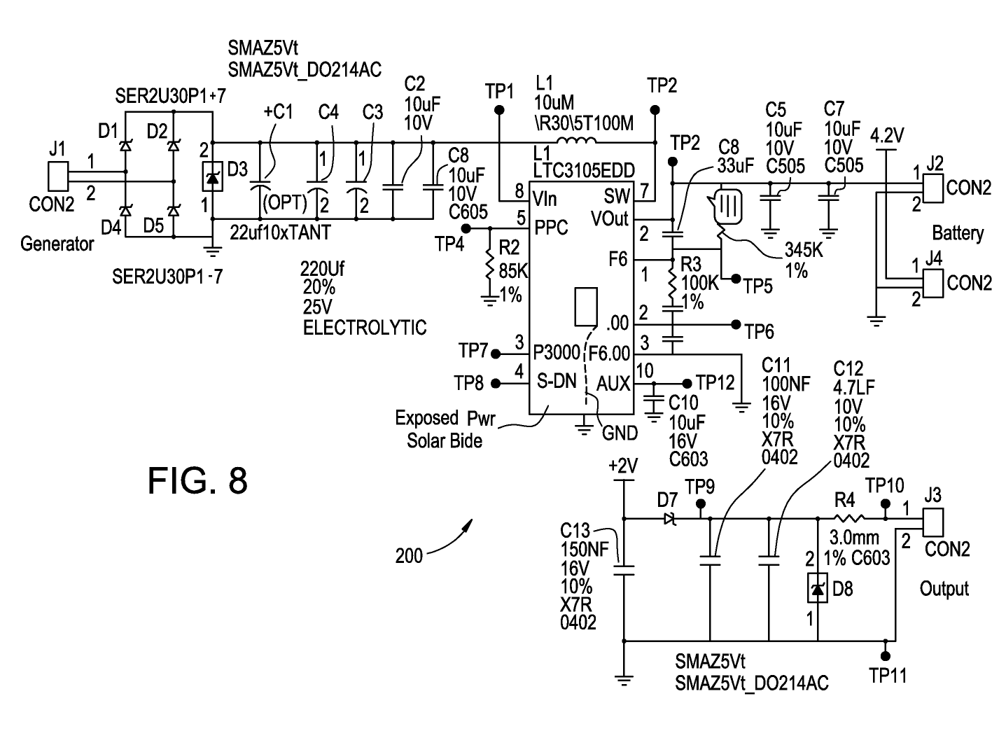

The battery 96 is disposed in the cavity 68 of the housing 60 and the battery 96 is in electrically coupled to the electric generator 90. In the disclosed embodiment, the electric generator 90 and the battery 96 are connected via a printed circuit board 100. The printed circuit board 100 is secured to a pedestal (not shown in the FIGS) extending from an inner surface 61 of the first section 62 of the housing 60. A circuit diagram 200 for the printed circuit board 100 in accordance with one embodiment of the present invention is shown in FIG. 8. Although a specific circuit diagram 200 for the printed circuit board 100 is shown in FIG. 8, the present invention is not limited in this regard and many different configurations may be employed. Some embodiments do not include a printed circuit board 100. In the embodiment shown, the battery 96 comprises a 3.7 volt 800 mAh lithium-ion battery, although many different configurations of batteries may be employed with the present invention. The battery 96 receives and stores at least a portion of the electrical energy generated by the electric generator 90.

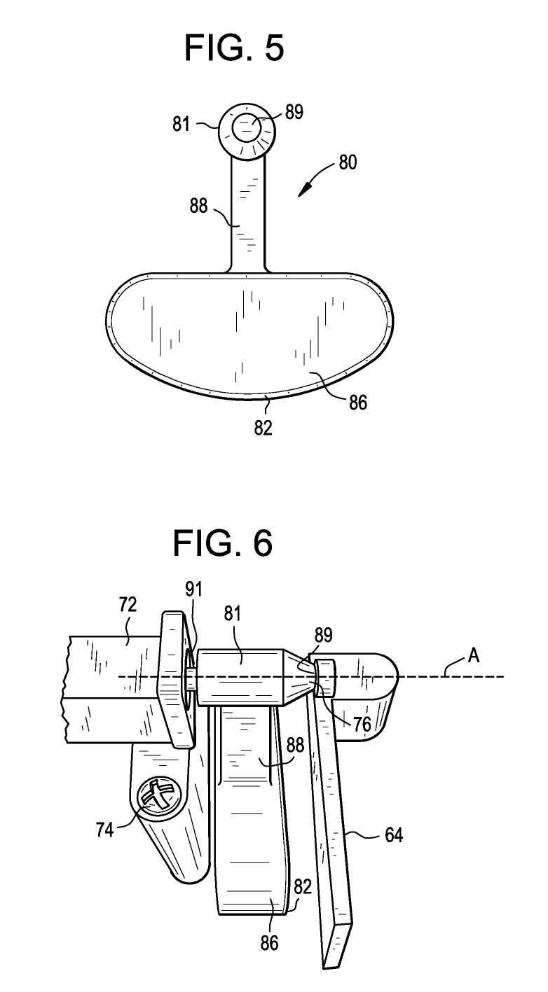

In specific reference to FIG. 5, the pendulum 80 includes a rod 88 that extends along a linear axis between a proximal end 81 and a distal end 82. The pendulum 80 rotates about a first axis of rotation A (shown in FIGS. 4 and 6) at or proximate to its proximal end 81. The axis of rotation A of the pendulum 80 is perpendicular to the rod 88. The pendulum 80 includes a recess (not shown in the figures) proximate to the proximal end 81 for receiving the rotor 92 of the electric generator 90. The recess is configured so that when the rotor 92 is received therein an axis of rotation of the rotor is coaxial with the first axis of rotation A. The rotor 92 may be secured in the recess of the pendulum 80 by any known method, including by a press-fit, an adhesive, or by a mechanical fastener. A portion of the pendulum 80 proximate to the proximal end 81 and laterally displaced from the recess along the first axis of rotation A of the pendulum 80 terminates in truncated cone 89 (shown in FIGS. 2 and 5).

In specific reference to FIGS. 4 and 6, the pendulum 80 is supported in the housing 60 by a first support and a second support. The first support is the rotor 92 being received in the recess of the pendulum 80 which is coaxial with the first axis of rotation A. The second support is a bearing 76 received in the housing 60. The truncated cone 89 is received in the bearing 76. This configuration of supporting the pendulum 80 limits the pendulum to the single axis of rotation A regardless of which direction the ball 10 is rotating during play. The housing 60 is configured so that the pendulum 80 can rotate completely about the first axis of rotation A. The pendulum 70 includes a bob 86 at or proximate to its distal end 82. In the embodiment shown, the pendulum 80 is die cast from zinc and is approximately 30 grams. The present invention is not limited in this regard as different materials and masses may be readily employed.

In reference to FIG. 4, the generation module 60 includes a socket 110 electrically coupled to the battery 96. The socket 110 extends from a portion of the housing 60 of the generation module 50. The socket 110 is accessible through the opening defined by the panel 30. A cap 38 closes the opening 36 defined by the panel 30 during play and the socket 110 is accessible from outside the ball 10 when the cap 38 is removed from the opening defined by the panel 30.

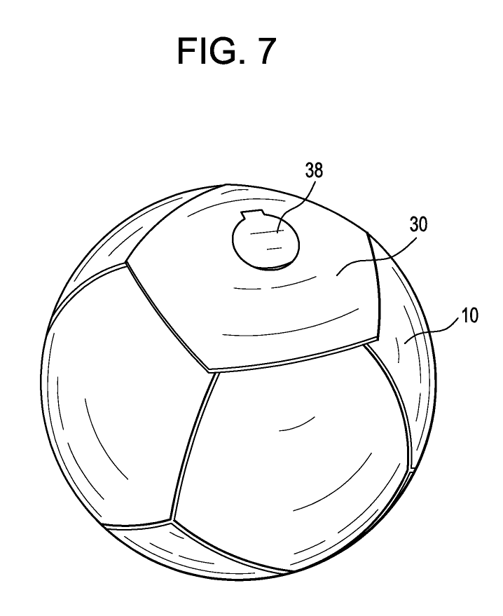

The generation module 50 is disposed in the cylindrical sleeve 32 that extends radially inward from the inner surface 34 of the panel 30. In the disclosed embodiment, the inside of the sleeve 32 has a similar profile as a cross section of the generation module 50 to facilitate disposal of the generation module in the sleeve. The generation module 50 is secured in the sleeve 32 using an adhesive, press-fit, and/or some other known method. In the embodiment shown, the adhesive comprises CA-SI-30 Cyanoacrylate. After the generation module 50 is secured in the sleeve 32 the sleeve is inserted through the opening 24 in the shell 20. As shown in FIG. 7, the panel 20 substantially closes the opening 24 in the shell 20. In the embodiment shown, the panel 30 is shaped as a pentagon to appear as a panel of the ball. In some embodiments of the present invention, the opening 24 and the panel 30 define a tongue and groove arrangement to provide a uniform closing of the opening 24 and to provide a smooth outer surface of the shell 10, especially at the point of transition between the outer surface of the panel 30 and the outer surface of the shell proximate to the panel 30. In some embodiments, the panel 30 is secured to an area of the shell proximate to the opening 24 using an adhesive of some other method known in the art. In the embodiment shown, the adhesive comprises CA-S1-30 Cyanoacrylate. This adhesive was selected because it provides good adhesion over time in a ball subject to stresses encountered during recreational use. In further reference to FIG. 7, a coating of paint may be applied to the outside surface of the shell 20 of the ball 10.

After assembly, a distal end of the sleeve 33 extends through the cavity 22 and contacts an opposite wall of the shell 20. In this manner, the sleeve 32 increases the rigidity of the ball 10. This is an important aspect in emulating the feel of a standard soccer ball with the ball 10 of the present invention, which unlike standard soccer balls does not include a bladder of pressurized air. It should be understood that the present invention is not limited in this regard, and that the sleeve may not extend to the opposing side of the shell 10. In yet further embodiments, the sleeve is not included in the design. In some embodiments, foam may be inserted into the cavity 22 of the shell 20 to further enhance structure of the ball 10.

During recreational use of the ball 10, the ball is accelerated relative to a playing surface for a period of time. These accelerations induce rotation of the pendulum 80 about the first axis of rotation A. This rotation is transferred to the rotor 92 by virtue of the connection between the pendulum 80 and the rotor 92. The rotor 92 rotates the electric generator 50 thereby generating electricity. At least a portion of this electricity is transmitted to and stored in the batty 96.

The electrical energy stored in the battery 96 can be accessed through the socket 110. The cap 38 is first removed and an electric cord compatible with the socket 110 is inserted therein. The electrical energy may be used to power a device that requires electricity for operation. For example, the electrical energy may be used to power a light, a telephone, a radio, etc. In some embodiments of the present invention, the electrical energy stored in the battery 96 can be used by a device included in the ball, for example, one or more lights or a global positioning system. In some of these embodiments, the ball 10 does not include a socket 110.

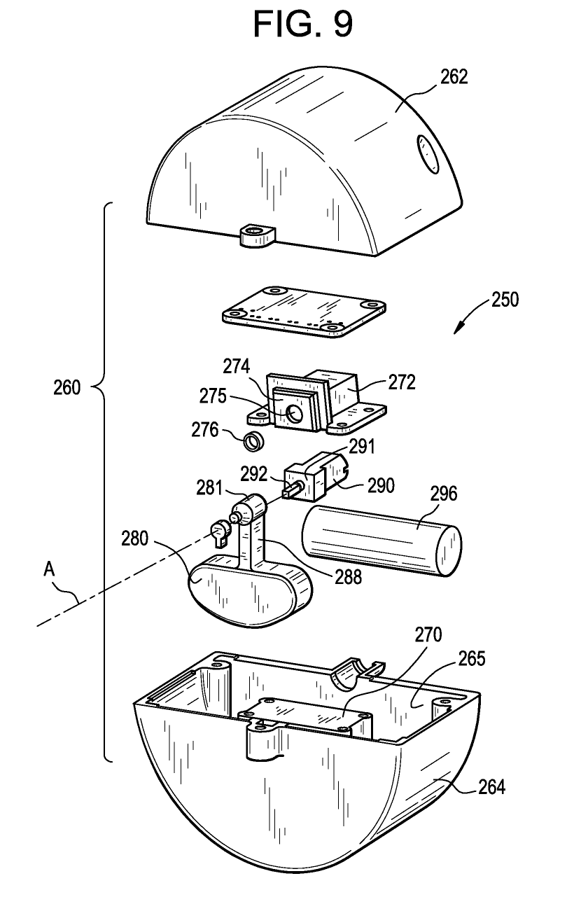

In reference to FIG. 9, an exploded view of a generation module 250 in accordance with one embodiment of the present invention in shown. The generation module 250 includes a housing 260, a pendulum 280, an electric generator 290, a battery 296, and supporting hardware including one or more brackets and fasteners as discussed in detail below. The housing 260 includes a first section 262 and a second section 264. The electric generator 290 is mounted on pedestal 270 extending from an inner surface 265 of the second section 264 of the housing 260. A U-shaped bracket 272 is mounted over the electric generator 290 and to the pedestal 270 using a plurality of fasteners (not shown in the FIG. 9) to secure the electric generator 290 to the pedestal 270. The electric generator 290 includes a rotor 292 extending from a surface 291 of the electric generator 290.

The pendulum 280 rotates about a first axis of rotation A at or proximate to a proximal end 281 of the pendulum 280. The first axis of rotation A of the pendulum 280 is perpendicular to a rod 288 of the pendulum 280. The pendulum 280 includes a recess (not shown in the figures) proximate to the proximal end 281 for receiving the rotor 292 of the electric generator 290. The recess is configured so that when the rotor 292 is received therein an axis of rotation of the rotor is coaxial with the first axis of rotation A. The rotor 292 may be secured in the recess of the pendulum 280 by any known method, including by a press-fit, an adhesive, or by a mechanical fastener. The rotor 292 is inserted through an opening 275 in a faceplate 274 of the U-bracket 272 and through a washer 276 before being inserted into the recess of the pendulum 280. The faceplate 274 and the washer 276 serve to maintain the pendulum 280 rotating about a single axis of rotation, the first axis of rotation A, regardless of the axis(es) of rotation of the ball. The faceplate 274 further inhibits radial forces from being transferred from the pendulum 280 to the electric generator 290 along the rotor 292.

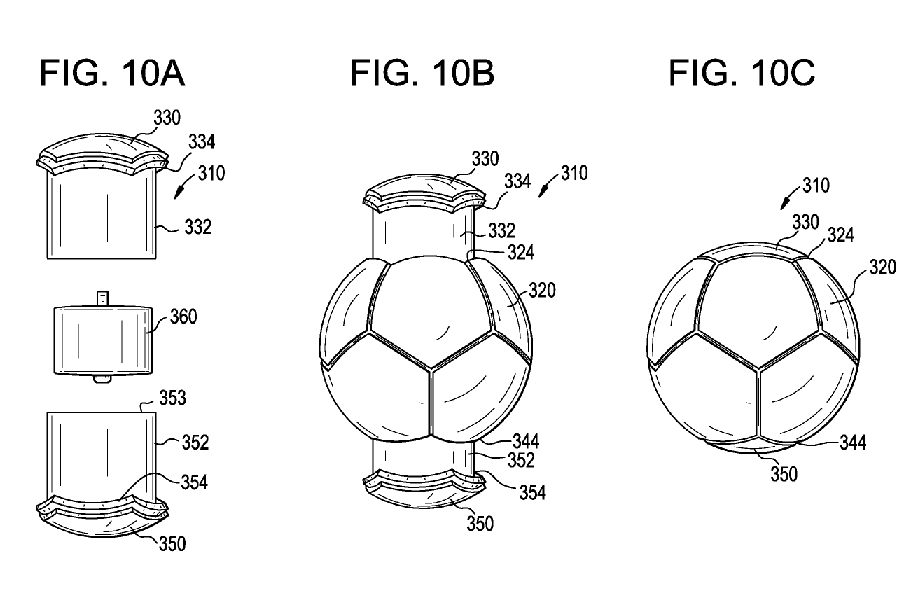

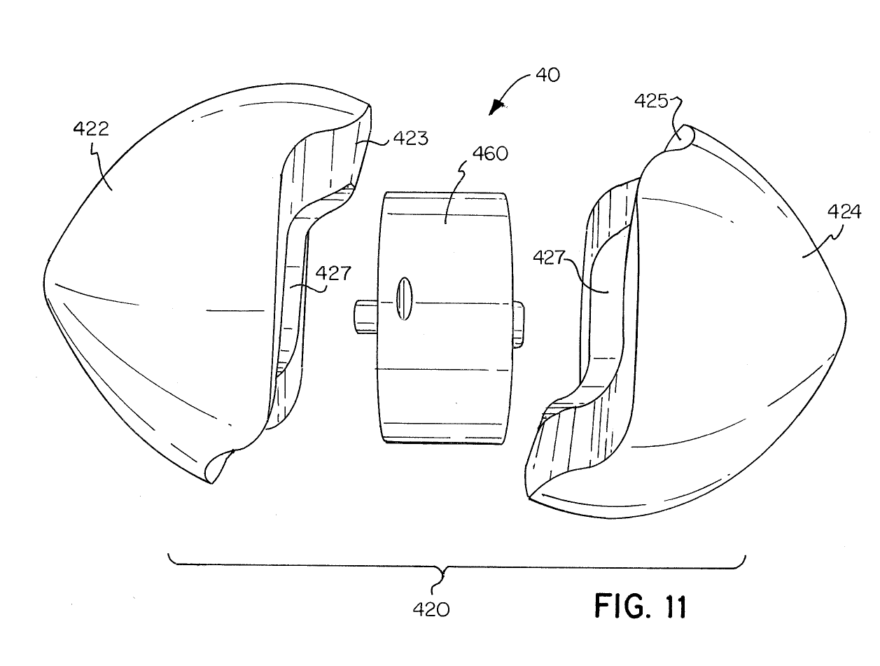

In reference to FIGS. 10A-10C, a ball 310 in accordance with on embodiment of the present invention is shown. The ball 310 includes a generally spherical shell 320 that defines a cavity. The ball 310 includes a generation module 360 that harnesses kinetic energy of the ball 310 to generate and store electrical energy. The shell 320 defines a first opening 324 for accessing the cavity and includes a first panel 330 for substantially closing the first opening 324. The first panel 330 includes a cylindrical sleeve 332 that extends radially inward from an inner surface 334 of the first panel 330. The shell 320 defines a second opening 344 for accessing the cavity and includes a second panel 350 for substantially closing the second opening 344. In the embodiment shown, the second opening 344 is substantially opposite the first opening 324 in the shell 320. The second panel 350 includes a cylindrical sleeve 352 that extends radially inward from an inner surface 354 of the second panel 350.

During assembly the generation module 360 is secured in one or more of the first sleeve 332 and the second sleeve 353. The first panel 330 and the second panel 350 are secured in the respective first opening 324 and second opening 344 so that the first sleeve 332 and the second sleeve 352 are disposed in the cavity. In some embodiments, the first sleeve 332 is adapted to receive a distal portion 353 of the second sleeve 352 when the first sleeve 332 and the second sleeve 352 are fully inserted into the shell 320 thereby increasing the rigidity of the assembled ball 310. In yet other embodiments, a portion of the generation module 360 is received in the first sleeve 332 and a portion of the generation module is received in the second sleeve 352 when the first sleeve and the second sleeve are fully inserted into the shell 320 thereby increasing the rigidity of the assembled ball 310. One of the first and the second panel 330, 350 includes an opening for an outlet, however, the present invention is not limited in this regarding as there may be more than one outlet or no outlets.

In reference to FIG. 11, an exploded view of an American football 410 in accordance with on embodiment of the present invention is shown. The football 410 includes a shell 420 that defines a cavity. An exterior surface of the shell 420 defines a prolate spheroid. The prolate spheroid is, for example, shaped as an American football or as a rugby football. The shell 420 includes a first portion 422 and a second portion 424. The first portion 422 defines a first edge 423 and the second portion 424 defines a second edge 425.

In the embodiment shown in FIG. 11, the first edge 423 and the second edge 425 are symmetric such that when the first edge 423 is held adjacent to the second edge 425, the outer surfaces of the first portion 422 and the second portion 424 define a continuous surface. The first potion 422 and the second portion 424 further define a cavity 427 when the first edge 423 is adjacent to the second edge 425. In the embodiment shown, the shell 420 is made from polyurethane, however, it should be understood that the present invention is not limited in this regard as many different types of materials made be used to form the shell 420 and the portions thereof 422, 424.

The football 410 includes a generation module 460 that harnesses kinetic energy of the ball 410 to generate and store electrical energy. The energy module 460 is disposed in the cavity defined by the first portion 422 of the shell 420 and by the second portion 424 of the shell. After the generation module 460 is disposed in the cavity, the first shell 422 and the second shell 424 are secured together, for example, by adhesive, hook and loop fasteners, an outer sleeve, stitching or by any other known means to secure such a configuration. The generation module 460 may be similar to that described above in reference to the soccer ball embodiment. One of the first and the second portions 422, 424 may include an opening for an outlet for accessing electrical energy stored in a battery stored in the generation module 460, however, the present invention is not limited in this regarding as there may be more than one outlet or no outlets. In some embodiments of the present invention a pendulum inside the generation module 460 is configured such that an axis of a pivot of the pendulum disposed in the generation module is parallel to an axis extending between two poles of the prolate spheroid.

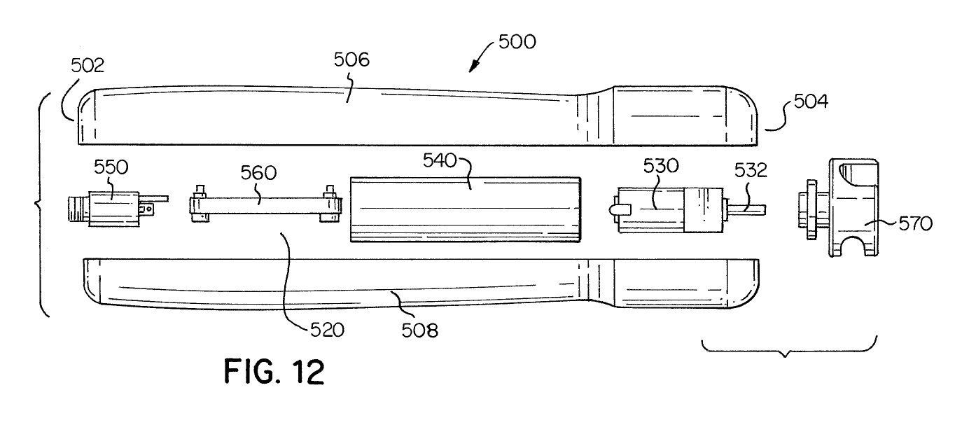

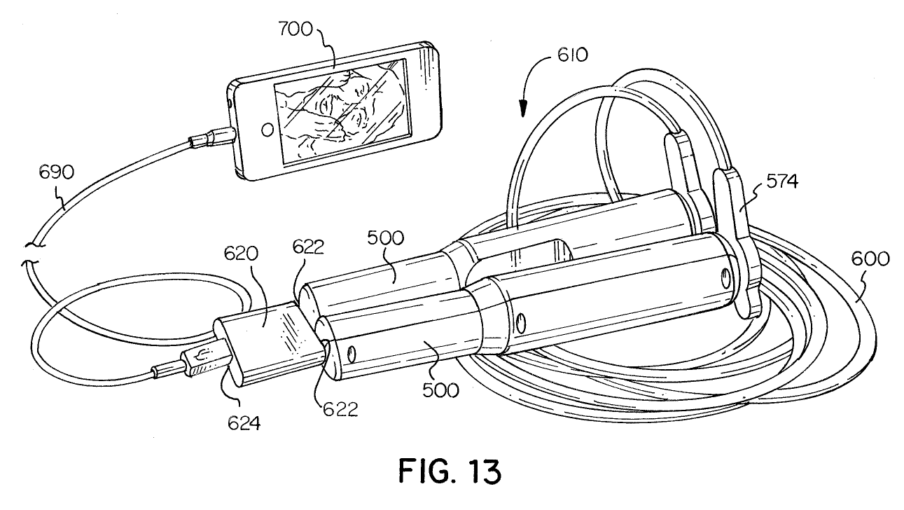

In reference to FIGS. 12-13, a jump rope handle 500 in accordance with one embodiment of the present invention is shown. The jump rope handle 500 includes a generation module disposed therein. As is commonly known, a jump rope typically has two handles and a length of rope extending there between. It should be understood that the term “rope” is used in this description in the broadest sense as it pertains to jump ropes and it is not intended to limit the present invention to any specific configuration or material. As used herein, the term rope can refer to any type of flexible line, such as cord, rope, twine, elastic, etc., that is capable of connecting two handles together and that enable use of the jump rope in accordance with known methods. During one known method of use, a handle is held in each hand of a user of the jump rope. The user continuously swings the rope over his head and under his legs. During this rotation, the rope rotates about an end of each handle. The inventors have discovered that it is possible to harness and store energy from the rotation of the rope about the axis of the handle.

In reference to FIG. 12, the handle 500 extends along an axis between a first end 502 and a second end 504. In the embodiment shown, the handle 500 comprises a first shell half 506 and a second shell half 508. Each shell 506, 508 extends along the axis from the first end 502 to the second end 504. The shells 506, 508 are configured to join together along an edge of each shell. To form the handle, the shells 506, 508 are joined together and are fixed relative to each other, for example, by a snap fit, by a fastener, or by some other means known in the art. In reference to FIG. 12, the second shell half 508 includes holes for receiving screws (not shown in FIG. 12).

The shells 506, 508 define an interior cavity 520 that extends from the first end 502 to the second end 504 of the handle. In some embodiments of the present invention, the shells 506, 508 are molded from a plastic, however, any known method of manufacture may be used to form the shells. In reference to FIG. 12, the outer surface of the handle 510 defines a geometry that is ergonomically shaped for holding the handle during use of the jump rope. It should be understood, however, that the present invention is not limited in this regard.

A generation module is disposed, at least partially, in the cavity 520. The generation module includes an electric generator 530, a battery 540, and an outlet 550. The generator 530, battery 540, and socket 550 are electrically coupled together via a printed circuit board 560. In the embodiment shown, the generator 530, the battery 540, and the socket 550 are electrically coupled to the printed circuit board 560 via wires (not shown in FIGS). In some embodiments of the present invention all or a portion of the generator 530, battery 540, an outlet 550 may directly connected to the circuit board, and, in other embodiments, wires or other forms of electric leads are used.

A rope 600 (shown in FIG. 13) is attached to the handle 500 via a bearing 570 proximate to the second end 504 of the handle 500. The bearing 570 is mechanically coupled to a rotor 532 extending from generator 530. The shells 506, 508 are configured to retain the bearing 570 in the second end of the handle 500. The rope 600 is fixed to the bearing 570 via a slot 572 in the bearing. In some embodiments, a protective shell 574 (shown in FIG. 13) is enclosed the bearing after the rope 600 is connected. The bearing 570 is retained inside the second end of the handle 500, such that a portion of the bearing can rotate about the axis of the handle 500 relative to the handle, while a second portion of the bearing 500 remains fixed about the axis and relative to the handle 500.

During use of the jump rope, the rope 600 causes a rotation a portion of the bearing 570 relative to handle 500. The rotating portion of the bearing is connected to the rotor 532, thereby rotating the rotor 532 and causing the generator to generate electrical energy. The battery 540 receives and stores at least a portion of the electrical energy generated by the electric generator 530. In the embodiment shown, the electric generator 530 comprises a direct current motor. A gear ratio and motor are selected to optimize generation of electrical energy and the range of rotation expected during use of the jump rope. In some embodiments of the present invention, the bearing 570 further comprises a geared transmission, such that a single rotation of the bearing caused by the rope results in more than one rotation being mechanically transferred to the rotor 532 of the generator 530.

In the embodiment shown, the electric generator 530 may be similar to that described above in relation to the soccer ball embodiment. For example, the gear ratio and generator may be selected to optimize generation of electrical energy with a jump rope. It should be understood that the type and gearing of the electric generator is not limited to this embodiment and a person of ordinary skill in the art being familiar with this disclosure would recognize that different gearing and motor combinations may be used with the present invention.

The battery 540 is disposed in the cavity 520 of the handle 500 and the battery 540 is in electrically coupled to the electric generator 530. In the disclosed embodiment, the electric generator 530 and the battery 540 are connected via a printed circuit board 560. The generator 530, battery 540, outlet 550, and printed circuit board 560 are fixed in the cavity 520 relative to the handle 510. A socket 550 is electrically coupled to the battery 540, either directly or via the circuit board 570. The socket 550 is accessible through an opening in the first end 502 of the handle 500.

In reference to FIG. 13, a jump rope 610 in accordance with the present invention is shown. The jump rope 610 includes two handles 500, each having a generator module disposed therein, and a rope 600 extending therebetween. During recreational use of the jump rope 610, the rope 600 rotates about the axis of the handle 500. This rotational energy is transferred to the rotor 532 of the electric generator 530. The rotor 532 rotates the electric generator 530 thereby generating electricity. At least a portion of this electricity is transmitted to and stored in the battery 540. The electrical energy stored in the battery 540 can be accessed through the socket 550 disposed in the cavity of the handle 500 proximate to the first end 502 thereof. The circuit board 570 regulates the storage of electricity in the battery 540. The electrical energy may be used to power or charge a device that requires electricity for operation. For example, the electrical energy may be used to power a light, a telephone, a radio, etc. In other embodiments, the electrical energy may be used to charge a device, such as a smart phone of a flash light. In some embodiments of the present invention, the electrical energy stored in the battery can be used by a device included in the jump rope.

In reference to FIG. 13, and adapter is shown 620. Each handle includes a generator module and outlet at its first end. The adapter 620 includes two jacks 622 configured to be received in the each outlet 550 of the handles 500 as shown in FIG. 13. The adapter 620 further includes a USB outlet 624 that is electrically coupled to the two jacks 622. In the embodiment shown, a smart phone 700 is connected to the USB port via a charging cable 690 charging to the jump rope via the outlets 560 in each handle 500. Using the configuration shown in the embodiment disclosed in FIGS. 12-13, it has been found that fifteen minutes of jumping rope can generate and store enough power to provide a 50% charge of a smart phone battery. It should be understood, that although a specific configuration and connector is shown, the present invention is not limited in this regard, and that a person of ordinary skill in the art and familiar with this invention, will understand that other configurations may be employed.

Although the present invention has been disclosed and described with reference to certain embodiments thereof, it should be noted that other variations and modifications may be made, and it is intended that the following claims cover the variations and modifications within the true scope of the invention.

What is claimed is:

1. An energy harvesting device, comprising:
a first shell having a longitudinal axis, wherein the first shell defines a cavity; and
a second shell, wherein the second shell is mechanically connected to the first shell via a flexible cord,
wherein the cavity comprises therein a bearing, an electrical generator, and a battery, wherein the bearing is mechanically coupled to a rotor of the electrical generator at a first end and an end of the flexible cord at a second end, such that rotation of the flexible cord about the longitudinal axis rotates at least a portion of the bearing to generate electrical power, and wherein the rotor is in electrical communication with the battery, such that the battery stores at least a portion of the electrical power generated by the electrical generator.

2. An energy harvesting device, comprising:
a first shell having a longitudinal axis, wherein the first shell defines a cavity and comprises a power socket accessible from an outer surface of the first shell; and
a second shell, wherein the second shell is mechanically connected to the first shell via a flexible cord,
wherein the cavity comprises therein an electrical generator and a battery, wherein the battery is in electrical communication with the electrical generator and the power socket and the electrical generator is mechanically coupled to an end of the flexible cord, such that rotation of the flexible cord about the longitudinal axis is configured to generate electrical power which is substantially stored in the battery and accessible via the power socket.

3. An energy harvesting device, comprising:
a first shell having a first longitudinal axis, a first end, and a second end, wherein the first shell defines a first cavity and comprises a first power socket accessible from an outer surface of the first end of the first shell; and
a second shell having a second longitudinal axis, a first end, and a second end, wherein the second shell defines a second cavity, and wherein the second shell comprises a second power socket accessible from an outer surface of the first end of the second shell, and wherein the second end of the first shell and the second end of the second shell is mechanically connected via a flexible cord, and
wherein each of the first cavity and the second cavity comprises therein an electrical generator and a battery, wherein the battery is in electrical communication with the electrical generator, and a rotor of the electrical generator is mechanically coupled to a different end of the flexible cord, such that rotation of the flexible cord about the first longitudinal axis and the second longitudinal axis is configured to generate electrical power which is substantially stored in the battery and accessible via the first power socket and the second power socket for the first cavity and the second cavity, respectively, and
wherein the first power socket and the second power socket are configured to output electrical power to the same adapter substantially simultaneously.
